(19) United States
(12) Patent Application Publication
(10) Pub. No.: US 2016/0149766 A1
(43) Pub. Date: May 26, 2016

(54) CLOUD BASED MANAGEMENT OF STORAGE SYSTEMS

(71) Applicant: PURE Storage, Inc., Mountain View, CA (US)

(72) Inventors: Benjamin Borowiec, Santa Clara, CA (US); John Colgrove, Los Altos, CA (US); Alan S. Driscoll, Fremont, CA (US); Terry Noonan, Vadnais Heights, MN (US)

(21) Appl. No.: 14/550,655

(22) Filed: Nov. 21, 2014

(51) Int. Cl. H04L 12/24; G06F 3/0481

(52) U.S. Cl. CPC H04L 41/22; G06F 3/0481

(57) ABSTRACT

Systems, methods, and computer readable storage mediums for managing multiple storage subsystems from the cloud. An organization with multiple storage subsystems may use a management service to monitor the storage subsystems from the cloud. The management service may automatically discover a new storage subsystem for the organization from the performance data generated by the new storage subsystem. An authorized user may login to the management service to view the status of multiple storage subsystems of the organization. The management service may also enable authorized users logging in from within the organization's network to push configuration updates to multiple storage subsystems via the cloud.

### BACKGROUND

1. Technical Field

Embodiments described herein relate to storage systems, and more particularly, to techniques for managing a storage environment via a cloud-based assist service.

2. Description of the Related Art

As computer memory storage and data bandwidth increase, so does the amount and complexity of data that businesses daily manage. Large-scale distributed storage systems, such as data centers, typically run many business operations. A distributed storage system may be coupled to client computers interconnected by one or more networks. To manage and store ever increasing amounts of data, storage systems tend to grow in size and complexity over time. Due to the expanding nature of data and increasing complexity of storage systems, managing storage environments can be a difficult and complex task.

### SUMMARY

Various embodiments of systems and methods for utilizing a cloud-based management service to manage a plurality of storage subsystems.

In one embodiment, a storage system may comprise a plurality of storage subsystems (e.g., storage arrays), and the storage system may be coupled to a cloud assist service. The storage subsystems may be configured to generate performance data and phone home the performance data on a periodic basis to the cloud assist service. The cloud assist service may be configured to provide a management service to enable an authorized user to manage the plurality of storage subsystems of the storage system. The management service may enable users to manage and maintain their entire infrastructure of on-premise storage subsystems from any browser.

In one embodiment, a first organization may have a plurality of storage subsystems. The cloud assist service may be configured to receive performance data from the plurality of storage subsystems of the first organization and to assist the storage subsystems with analyzing performance data, generating alerts, providing a management service, as well as a variety of other functions. In one embodiment, the cloud assist service may be configured to dynamically populate the management service from performance data received from the plurality of storage subsystems of the first organization. The management service may be configured to allow authorized users to manage any of the first organization's storage subsystems from a single website. Authorized users may be able to login through the website and manage the storage environment through the website.

In one embodiment, a first storage subsystem may generate performance data and send the performance data to a cloud assist service. The cloud assist service may determine the organization to which the first storage subsystem belongs in response to receiving the performance data from the first storage subsystem. The first storage subsystem may then be automatically added to the organization's management service view if it was not already included within the management service view.

Configuration updates may be pushed from the management service in the cloud to one or more storage subsystems for a given organization if this action has been initiated by an authorized user. In one embodiment, a user may only be able to push configuration updates to storage subsystems if the user is connecting to the management service from within the given organization's network. Otherwise, the management service may prevent configuration updates from being pushed to any of the given organization's storage subsystems if the request is being initiated from outside the organization's local network.

These and other embodiments will become apparent upon consideration of the following description and accompanying drawings.

### BRIEF DESCRIPTION OF THE DRAWINGS

FIG. 1 is a generalized block diagram illustrating one embodiment of storage systems coupled to cloud assist logic.

FIG. 2 is a generalized block diagram illustrating one embodiment of a storage system.

FIG. 3 illustrates one embodiment of a GUI for managing a storage subsystem.

FIG. 4 illustrates one embodiment of a management service GUI for managing a plurality of storage subsystems.

FIG. 5 is a generalized flow diagram illustrating one embodiment of a method for hosting a management service for a first organization.

FIG. 6 is a generalized flow diagram illustrating one embodiment of a method for implementing a management service.

FIG. 7 is a generalized flow diagram illustrating one embodiment of a method for automatically discovering storage subsystems.

While the methods and mechanisms described herein are susceptible to various modifications and alternative forms, specific embodiments are shown by way of example in the drawings and are herein described in detail. It should be understood, however, that drawings and detailed description thereto are not intended to limit the methods and mechanisms to the particular form disclosed, but on the contrary, are intended to cover all modifications, equivalents and alternatives apparent to those skilled in the art once the disclosure is fully appreciated.

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a plurality of storage subsystems . . . . ” Such a claim does not foreclose the system from including additional components (e.g., a network, a server, a display device).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, paragraph (f), for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

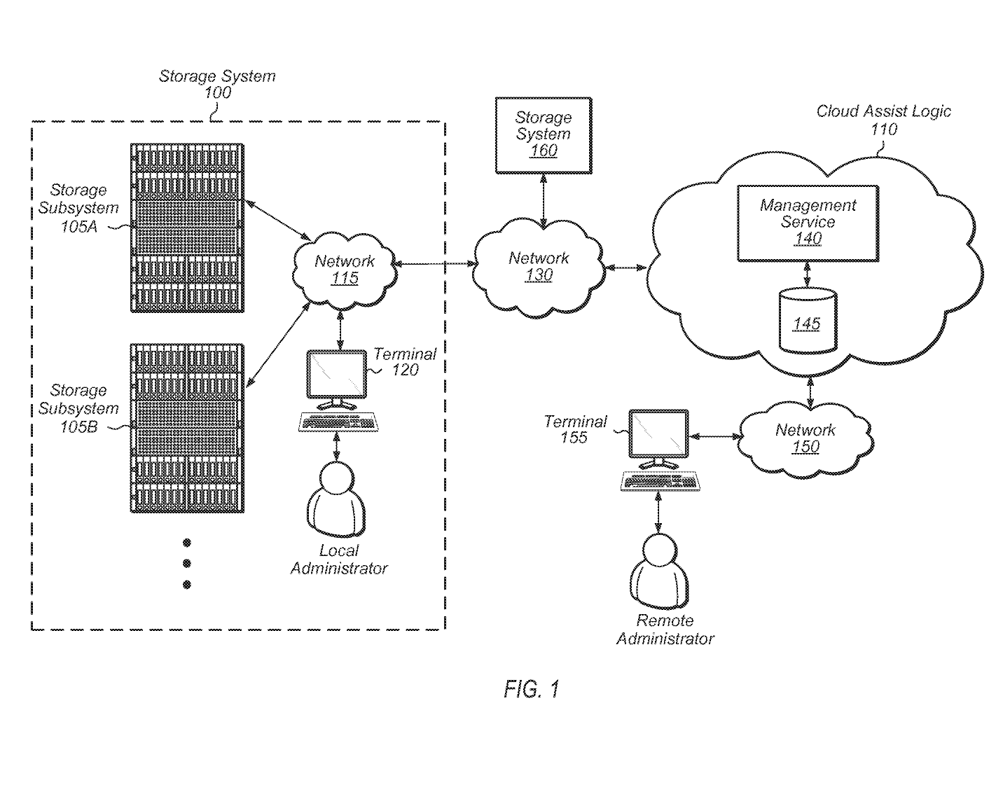

Referring now to FIG. 1, a generalized block diagram of one embodiment of a storage systems coupled to cloud assist logic 110 is shown. Storage system 100 may include storage subsystems 105A and 105B which are representative of any number and type of storage subsystems. Storage system 100 may also include network 115 and terminal 120, through which a local administrator may connect to cloud assist logic 110 and/or management service 140 for monitoring and managing storage subsystems 105A-B. In other embodiments, storage system 100 may have multiple networks connecting the plurality of storage subsystems 105A-B.

Storage system 160 may also be coupled to cloud assist logic 110, and storage system 160 may include any number of storage subsystems, networks, terminals, servers, and/or other physical appliances. In one embodiment, both storage system 100 and storage system 160 may belong to a first organization, although storage system 100 and storage system 160 may reside at different physical locations. It is to be understood that any number of additional storage systems may also belong to the first organization. Generally speaking, a plurality of storage systems belonging to the first organization at a plurality of locations may connect to cloud assist logic 110, and an administrator of the first organization may be able to login to management service 140 to manage these plurality of storage systems in a single view using a single interface.

Each of the storage subsystems of the first organization may be configured to send logs, diagnostics, performance data (e.g., capacity data, subsystem health), and configuration data to cloud assist logic 110 on a periodic basis. Cloud assist logic 110 may store the logs and data in database 145. Database 145 may be a comprehensive database used to store the data received from the plurality of storage subsystems of the first organization, and cloud assist logic 110 may access the first organization's data in database 145 when generating the management service 140 and corresponding graphical user interfaces (GUIs) for authorized users. In one embodiment, database 145 may include a separate database file corresponding to each storage subsystem of the first organization, and each separate database file may be updated when new phone home data is received from its respective storage subsystem. Additionally, a plurality of different organizations may utilize cloud assist logic 110 for managing their storage environments. Cloud assist logic 110 may be configured to virtually partition the data of the different organizations, and cloud assist logic 110 may also be configured to generate a separate management service 140 for each organization.

Each storage subsystem 105A-B may be any type of storage system depending on the embodiment. For example, in one embodiment, storage subsystems 105A-B may be storage arrays, and each storage array may include any number of storage controllers and any number of storage devices. The storage arrays may utilize different types of storage device technology, depending on the embodiment. For example, in one embodiment, the storage array may utilize flash (or solid-state) storage devices and may be an all-flash storage array. In other embodiments, the storage array may utilize other types of storage device technology and/or may combine different types of storage device technology in a single array.

In various embodiments, cloud assist logic 110 may include program instructions which when executed by a processor are configured to generate management service 140 for monitoring and managing the status of storage system 100. Cloud assist logic 110 may be configured to execute on a server, computer, or other computing device to perform the functions described herein. In some embodiments, cloud assist logic 110 may include hardware and/or control logic configured to perform the functions and tasks described herein. For example, cloud assist logic 110 may be implemented using any combination of dedicated hardware (e.g., application specific integrated circuit (ASIC)), configurable hardware (e.g., field programmable gate array (FPGA)), and/or software (e.g., program instructions) executing on one or more processors. It is noted that cloud assist logic 110 may also be referred to as cloud-based logic 110 or cloud assist service 110.

In one embodiment, cloud assist logic 110 may execute within a cloud computing platform provided by a web services provider (e.g., Amazon). The cloud computing platform may provide large amounts of computing assets and storage availability to cloud assist logic 110. In another embodiment, cloud assist logic 110 may execute on a separate system or network external to the local network of storage system 100, wherein cloud assist logic 110 may be described as executing on or residing in a private cloud.

Each storage subsystem 105A-B may be configured to generate a local graphical user interface (GUI) to allow a local administrator or other users to view the status and manage the performance of the subsystem. However, the local GUI may only allow the administrator to view the status of an individual subsystem. Accordingly, the local administrator may login to the management service 140 generated by cloud assist logic 110 to manage multiple storage subsystems from a single interface. In one embodiment, management service 140 may be generated by cloud assist logic 110 without requiring any software to be deployed within storage system 100 to support management service 140.

In one embodiment, the logs and performance data generated by storage systems 100 and 160 may be utilized by cloud assist logic 110 to populate status information for storage subsystems 105A-B within management service 140. For example, a remote administrator may login to cloud assist logic 110 via client 155 and network 150, and the remote administrator may utilize management service 140 to view the status of the plurality of storage subsystems of storage systems 100 and 160. In one embodiment, management service 140 may also be utilized to update the configuration of the plurality of storage subsystems when the request initiates from an authorized user (e.g., local administrator) on any network of the first organization. Accordingly, in this embodiment, the remote administrator may be prevented from pushing configuration to storage subsystems 105A-B since the remote administrator is logging in externally from storage systems 100 and 160. For the purposes of this discussion, it may be assumed that terminal 155 and network 150 are not associated with the first organization. Also, cloud assist logic 110 may be prevented from independently pushing configuration or otherwise making changes to any storage subsystems of the first organization if the request does not initiate from an authorized user logging in from one of the networks of the first organization.

Terminals 120 and 150 may be any type of physical computer terminals or computing devices. In one embodiment, terminals 120 and 150 may include thin-client software to enable access to server-provided resources while using minimal resources on terminals 120 and 150. Terminals 120 and 150 may also include web browsers (or browsers) for retrieving and presenting web pages and other content from webservers. Examples of browsers include Google Chrome™, Internet Explorer™, Firefox™, Safari™, Opera™, and others. Additionally, other types of client applications besides browsers may be utilized to access content from external servers.

Networks 115, 130, and 150 may be any of various types of networks, including a storage area network, the Internet, an intranet, a local area network (LAN), a wide area network (WAN), a wireless network, and others. Networks 115, 130, and 150 may further include remote direct memory access (RDMA) hardware and/or software, transmission control protocol/internet protocol (TCP/IP) hardware and/or software, router, repeaters, switches, grids, and/or others. Protocols such as Fibre Channel, Fibre Channel over Ethernet (FCoE), iSCSI, and so forth may be used in networks 115, 130, and 150. The networks 115, 130, and 150 may interface with a set of communications protocols used for the Internet such as the Transmission Control Protocol (TCP) and the Internet Protocol (IP), or TCP/IP.

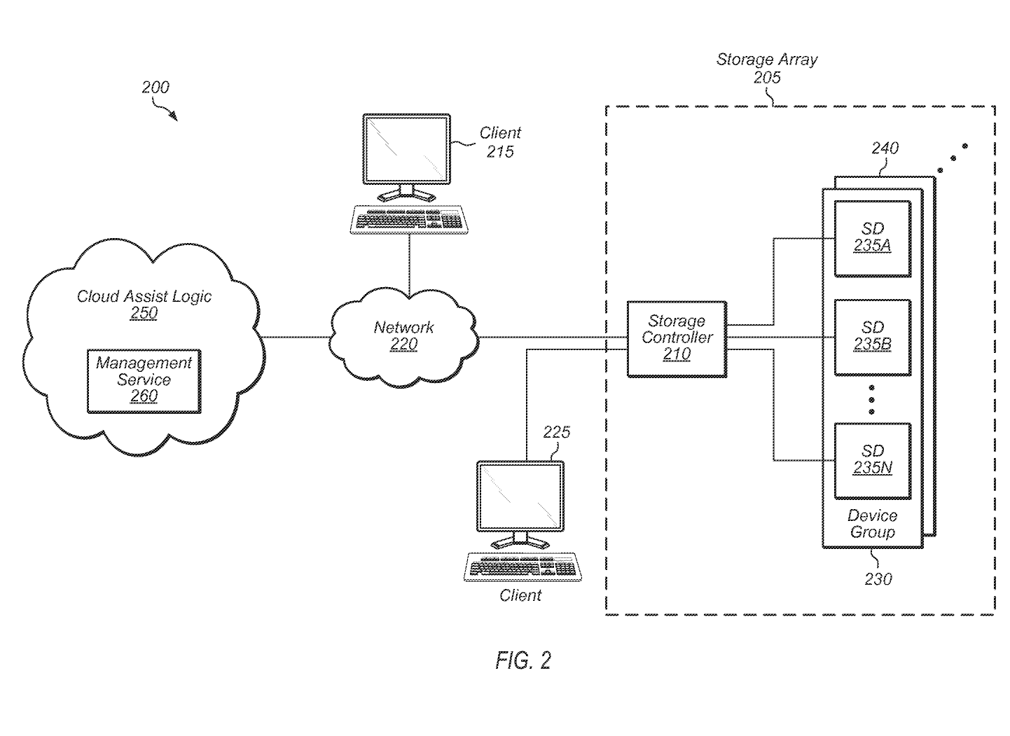

Turning now to FIG. 2, a generalized block diagram of one embodiment of a storage system 200 is shown. Storage system 200 may include storage array 205, clients 215 and 225, network 220, and cloud assist logic 250. Storage array 205 may include storage controller 210 and storage device groups 230 and 240, which are representative of any number of storage device groups. As shown, storage device group 230 includes storage devices 235A-N, which are representative of any number and type of storage devices (e.g., solid-state drives (SSDs)). It should be understood that while storage system 200 is shown as including one storage array, in other embodiments, storage system 200 may include a plurality of storage arrays. It is noted that storage array 205 may also be referred to as a storage subsystem or a storage system.

Storage array 205 may be configured to generate performance data and send the performance data to cloud assist logic 250. Cloud assist logic 250 may be configured to generate management service 260 to allow users to remotely login and view the status of storage array 205. Management service 260 may also provide a way for a user logging in from storage array 205 to push configuration data from the cloud to storage array 205.

Storage controller 210 of storage array 205 may be coupled directly to client computer system 225, and storage controller 210 may be coupled remotely over network 220 to client computer system 215. Clients 215 and 225 are representative of any number of clients which may utilize storage system 200 for storing and accessing data. It is noted that some systems may include only a single client, connected directly or remotely to storage controller 210. It is also noted that storage array 205 may include more than one storage controller in some embodiments.

Storage controller 210 may include software and/or hardware configured to provide access to storage devices 235A-N. Although storage controller 210 is shown as being separate from storage device groups 230 and 240, in some embodiments, storage controller 210 may be located within one or each of storage device groups 230 and 240. Storage controller 210 may include or be coupled to a base operating system (OS), a volume manager, and additional control logic for implementing the various techniques disclosed herein.

Storage controller 210 may include and/or execute on any number of processors and may include and/or execute on a single host computing device or be spread across multiple host computing devices, depending on the embodiment. In some embodiments, storage controller 210 may generally include or execute on one or more file servers and/or block servers. Storage controller 210 may use any of various techniques for replicating data across devices 235A-N to prevent loss of data due to the failure of a device or the failure of storage locations within a device. Storage controller 210 may also utilize any of various deduplication and/or compression techniques for reducing the amount of data stored in devices 235A-N.

In various embodiments, network 220 may be any of the previously described types of networks. Client computer systems 215 and 225 are representative of any number of stationary or mobile computers such as desktop personal computers (PCs), servers, server farms, terminals, workstations, laptops, handheld computers, servers, personal digital assistants (PDAs), smart phones, and so forth. Generally speaking, client computer systems 215 and 225 include one or more processors comprising one or more processor cores. Each processor core includes circuitry for executing instructions according to a predefined general-purpose instruction set. For example, the x86 instruction set architecture may be selected. Alternatively, the ARM®, Alpha®, PowerPC®, SPARC®, or any other general-purpose instruction set architecture may be selected. The processor cores may access cache memory subsystems for data and computer program instructions. The cache subsystems may be coupled to a memory hierarchy comprising random access memory (RAM) and a storage device.

It is noted that in alternative embodiments, the number and type of storage arrays, client computers, storage controllers, networks, storage device groups, and data storage devices is not limited to those shown in FIG. 2. At various times one or more clients may operate offline. In addition, during operation, individual client computer connection types may change as users connect, disconnect, and reconnect to system 200. Furthermore, the systems and methods described herein may be applied to directly attached storage systems or network attached storage systems and may include a host operating system configured to perform one or more aspects of the described methods. Numerous such alternatives are possible and are contemplated.

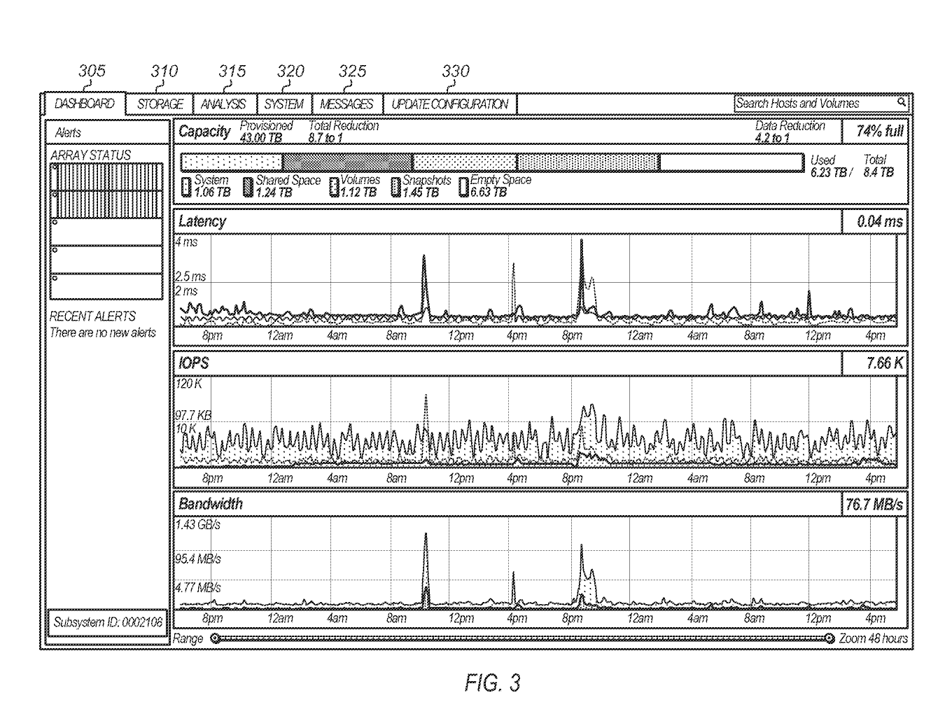

Referring now to FIG. 3, one embodiment of a GUI for managing a storage subsystem is shown. The storage subsystem status GUI may be generated by cloud assist logic (e.g., cloud assist logic 110 of FIG. 1) for users to login to for viewing the status of a given storage subsystem. An ID (0002108) of the given storage subsystem may be shown in the storage subsystem status GUI and in other embodiments, various other identifying information (e.g., IP address) may also be shown. The cloud assist logic may generate the storage subsystem status GUI using performance data generated by the given storage subsystem. The given storage subsystem may generate performance data on a periodic basis and send the data to the cloud assist logic. In various embodiments, the performance data may include subsystem ID, host name, storage device count, host count, volume count, queue depth, read bandwidth (BW), read IOPS, read latency, write BW, write IOPS, write latency, storage capacity utilization metrics, sequence number(s), and/or other data. The cloud assist logic may then utilize this data to populate the storage subsystem status GUI when an authorized user logs in to the cloud assist logic.

The storage subsystem status GUI may have multiple tabs as shown in FIG. 3. For example, the dashboard tab 305 is selected in the view shown in FIG. 3. The user may also be able to select other tabs as well, including a storage tab 310, analysis tab 315, system tab 320, messages tab 325, and update configuration tab 330. By selecting these tabs, the user may change the view of the GUI. In one embodiment, the cloud assist logic may allow the user to update the configuration of the given storage subsystem via the storage subsystem status GUI if the user is logging on from the network of the given storage subsystem. Otherwise, the cloud assist logic may prevent the user from updating the configuration of the given storage subsystem if the user is logging on from outside of the network of the given storage subsystem.

On the left side of the GUI, recent alerts may be listed. In the center of the GUI, the capacity of the storage system may be listed, with the provisioned storage listed as 43.00 terabytes (TB). The total reduction of data due to compression and deduplication is also listed in the capacity view as 8.7 to 1. The total reduction of data may vary depending on the type of data being stored and the amount of compression and deduplication that can be achieved. Also, the data reduction is listed as 4.2 to 1 in the capacity section of the storage subsystem status GUI. Additionally, the amount of storage space currently being utilized by the storage system is shown to the right of the data reduction value, with the current utilization listed as “74% full”.

A horizontal graph showing the utilization of storage capacity may also be shown in the storage subsystem status GUI. The capacity utilized for system data, shared space, volumes, snapshots, and empty space are shown in the storage subsystem status GUI. The storage subsystem status GUI also displays timeline charts of latency, input/output operations per second (IOPS), and bandwidth. A tool at the bottom of the GUI allows the user to select the range of these timeline charts and to zoom in or out. In the top right of the GUI, the user may enter in the names of hosts or volumes to search for, with the GUI returning the corresponding results depending on the user's search query.

It should be understood that the storage subsystem status GUI shown in FIG. 3 is merely one example of a GUI which may be used to monitor the status and manage the operations of a storage subsystem. It is noted that in other embodiments, the storage subsystem status GUI may display other information and/or omit some of the information shown in FIG. 3. Additionally, in other embodiments, the storage subsystem status GUI may be organized differently and may use other types of charts and graphs to display information to the user. For example, in another embodiment, a command line interface (CLI) may be utilized rather than a GUI, with the user issuing commands to the storage subsystem via the CLI. In a further embodiment, the cloud assist logic may support both a CLI and a GUI. Additionally, in some embodiments, the representational state transfer (REST) application programming interface (API) may be utilized to issue commands to the storage subsystem.

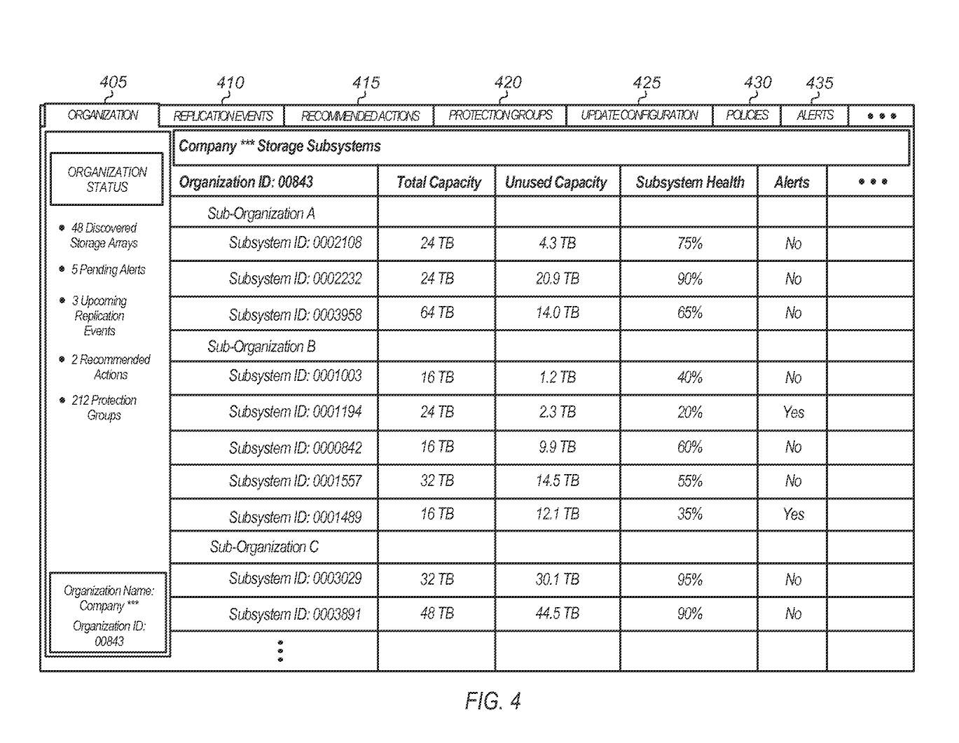

Turning now to FIG. 4, one embodiment of a management service GUI for managing a plurality of storage subsystems is shown. The management service GUI may be generated for an organization with multiple storage subsystems. The management service GUI may display a list of all of the storage subsystems of the organization in the center of the GUI. An individual storage subsystem may be selected from the list, and then a GUI similar to that shown in FIG. 3 may be generated to allow the user to manage and monitor the selected storage subsystem.

On the left side of the management service GUI, highlights of the status of the organization's overall storage environment may be listed. For example, the number of discovered storage arrays may be listed, which in this case is shown as 48 discovered storage arrays. Also, the number of pending alerts, upcoming replication events, recommended actions, and number of protection groups may be listed on the left side of the GUI. In other embodiments, additional information may be included with these highlights and/or some of the highlights shown may be omitted.

As the organization adds new storage arrays, the new storage arrays may be added to the management service GUI without requiring administrator intervention. For example, a new storage array may be configured to phone home performance data to the cloud assist service, and when the cloud assist service receives performance data for the first time from the new storage array, the cloud assist service may be configured to automatically discover the new storage array for the organization and list the new storage array in the management service GUI. For example, if a new storage array becomes operational after the point in time displayed in the management service GUI of FIG. 4, the management service may recognize the new storage array following the receipt of its performance data, and then the management service may update the number of discovered storage arrays from 48 to 49. The management service GUI may then include a link to the new storage array in the list of all discovered storage arrays to allow a user to view the status of the new storage array. The management service may be configured to automatically discover the new storage array and automatically update the relevant details for the GUI without user intervention. The management service GUI may also delete a storage array from the GUI when the storage array is removed from the storage environment. In one embodiment, an administrator may notify the management service when a given storage array has been removed. In another embodiment, the management service may delete the storage array after a certain amount of time has passed without the storage array phoning home. However, the management service may preserve historical information associated with deleted storage arrays.

The management service GUI may include an organization tab 405, and when tab 405 is selected, a summary of the status of the organization's storage environment may be displayed in the management service GUI. The management service GUI may also include an alerts tab 435 to display additional information regarding the alerts. The management service GUI may also include a replication events tab 410 to show a listing of upcoming replication events in more detail.

The cloud assist logic may be configured to generate recommendations, and the management service GUI may show a listing of recommended actions in tab 415 of the GUI. These recommended actions may be generated in response to an analysis of the performance data generated by the storage subsystems. In some cases, the organization may define a policy whereby the cloud assist service may perform the recommended actions automatically without user intervention. Alternatively, the organization may define a policy where an authorized user is required to authorize a recommended action before the recommended action can be performed.

For example, in one embodiment, the cloud assist logic may determine that a target subsystem of an upcoming replication event is currently experiencing degraded performance and therefore the replication event will likely take longer than expected. In one embodiment, the degraded performance could be caused by the target subsystem performing garbage collection operations. Therefore, the cloud assist logic may generate a recommendation that the replication event temporarily use a different target storage subsystem since the original target is currently performing garbage collection operations. Alternatively, the cloud assist logic may generate a recommendation that the replication event should be delayed until the original target finishes performing garbage collection operations. If the organization allows the cloud assist logic to perform actions based on recommendations without user intervention, the cloud assist logic may automatically implement the recommendation. For example, the cloud assist logic may choose a different storage subsystem as the temporary target of the upcoming replication event. The cloud assist logic may then cause the upcoming replication event to be performed to the temporary target chosen by the cloud assist logic, temporarily overriding the previous settings. When the original target finishes performing garbage collection operations, the temporary target may replicate the data to the original target.

Garbage collection operations may be defined as operations in which storage locations are freed and made available for reuse by the system. Additionally, garbage collection operations may also include read optimization operations which simplify the mappings of storage objects so as to make future lookups more efficient. In one embodiment, the cloud assist logic may determine a given storage subsystem is undergoing garbage collection operations based on an analysis of the latency data versus the IOPS for the given storage subsystem. In other embodiments, the cloud assist logic may utilize other techniques for determining that a storage subsystem is performing garbage collection operations.

The management service GUI may also include other tabs, such as a replication events tab 410, protection groups tab 420, update configuration tab 425, policies tab 430, alerts tab 435, and/or additional tabs depending on the embodiment. The protection groups tab 420 may generate a view of the various protection groups of the organization. A protection group may be defined as a group of hosts, host groups, and volumes within a storage subsystem or storage system. A single protection group may consist of multiple hosts, host groups and volumes. Generally speaking, a protection group may include logical storage elements that are replicated together consistently in order to correctly describe a dataset. The update configuration tab 425 may allow a user to update the software running on one or more storage subsystems and/or to perform other actions which modify the operations and settings of the storage subsystems. The policies tab 430 may allow a user to view and/or change the storage and protection policies which are implemented for their organization. The policies may specify which actions are allowed and which actions are prohibited, as well as defining which actions must be initiated by an authorized user and which actions may be initiated by the management service.

The cloud assist service may be configured to automatically detect the sub-organizations that the storage subsystems are associated with and display them as shown in FIG. 4. For example, for a given organization, sub-organizations may include engineering, corporate, information technology (IT), etc. In various embodiments, the sub-organizations may be determined from the domain names of the storage subsystems, assigned hierarchical tags, or other identifiers.

In one embodiment, a first organization may set a policy which specifies that only authorized users logging in to the cloud assist service from within the first organization can update configuration for the storage subsystems of the first organization. This prevents the cloud assist service from updating configuration for storage subsystems of the first organization without user intervention. A user may be able to update configuration by selecting the update configuration tab 425 and then selecting which storage subsystems to update. However, a second organization may have a defined policy which allows the cloud assist service to update configuration for the storage subsystems of the second organization without user intervention. Also, the second organization's policy may allow authorized users who are logging in from outside of the second organization's network to update configuration for the storage subsystems of the second organization. The management service and/or cloud assist service may be configured to track which policies are in place for a given organization and to allow or prevent actions based on the organization's policies.

It is noted that the management service GUI shown in FIG. 4 is only one example of a GUI which may be generated and presented to a user. In other embodiments, the management service GUI may be organized differently and/or include other types of information.

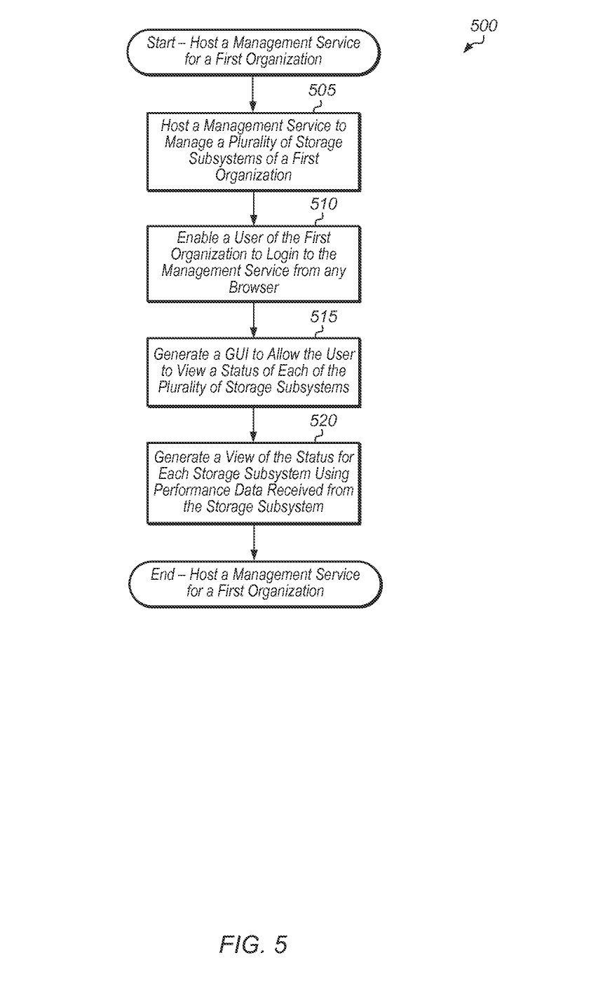

Referring now to FIG. 5, one embodiment of a method 500 for hosting a management service for a first organization is shown. Any of the servers, cloud assist logic units, and/or management services described herein may generally operate in accordance with method 500. In addition, the steps in this embodiment are shown in sequential order. However, some steps may occur in a different order than shown, some steps may be performed concurrently, some steps may be combined with other steps, and some steps may be absent in another embodiment.

A server may host a management service to manage a plurality of storage subsystems of a first organization (block 505). In one embodiment, the server may be external to the network of the first organization. In some embodiments, the server may be cloud-based and may include logic such as cloud assist logic 110 of FIG. 1. The server may be configured to enable a user of the first organization to login to the management service from any browser (block 510). The user may login to the management service from within a network of the first organization or alternatively, the user may login to the management service externally from any network of the first organization. The server may generate a GUI to allow the user to view a status of each of the plurality of storage subsystems (block 515). The server may generate a view of the status for each storage subsystem using performance data received from the storage subsystem (block 520). After block 520, method 500 may end.

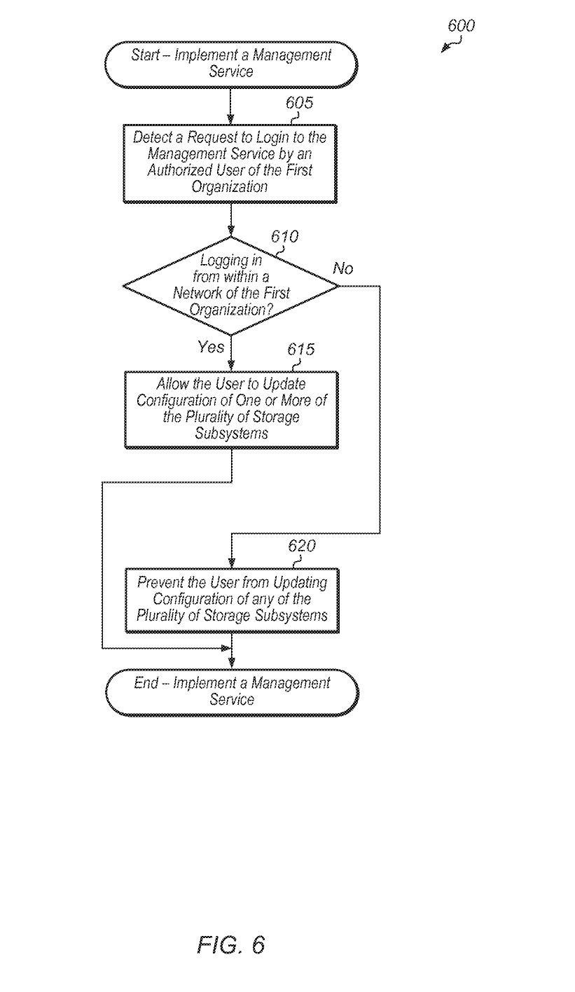

Referring now to FIG. 6, one embodiment of a method 600 for implementing a management service is shown. Any of the servers, cloud assist logic units, and/or management services described herein may generally operate in accordance with method 600. In addition, the steps in this embodiment are shown in sequential order. However, some steps may occur in a different order than shown, some steps may be performed concurrently, some steps may be combined with other steps, and some steps may be absent in another embodiment.

In response to detecting a request to login to a management service by an authorized user of a first organization (block 605), a server located externally to the first organization may be configured to determine if the user is logging in from within a network of the first organization (conditional block 610). In one embodiment, the server may determine if the request came from an IP address associated with the first organization. If the server determines that the user is logging in from within a network of the first organization (conditional block 610, “yes” leg), then the server may allow the user to update configuration of one or more of the plurality of storage subsystems of the first organization (block 615). If the server determines that the user is not logging in from within a network belonging to the first organization (conditional block 610, “no” leg), then the server may prevent the user from updating configuration of any of the plurality of storage subsystems of the first organization (block 620). After block 620, method 600 may end.

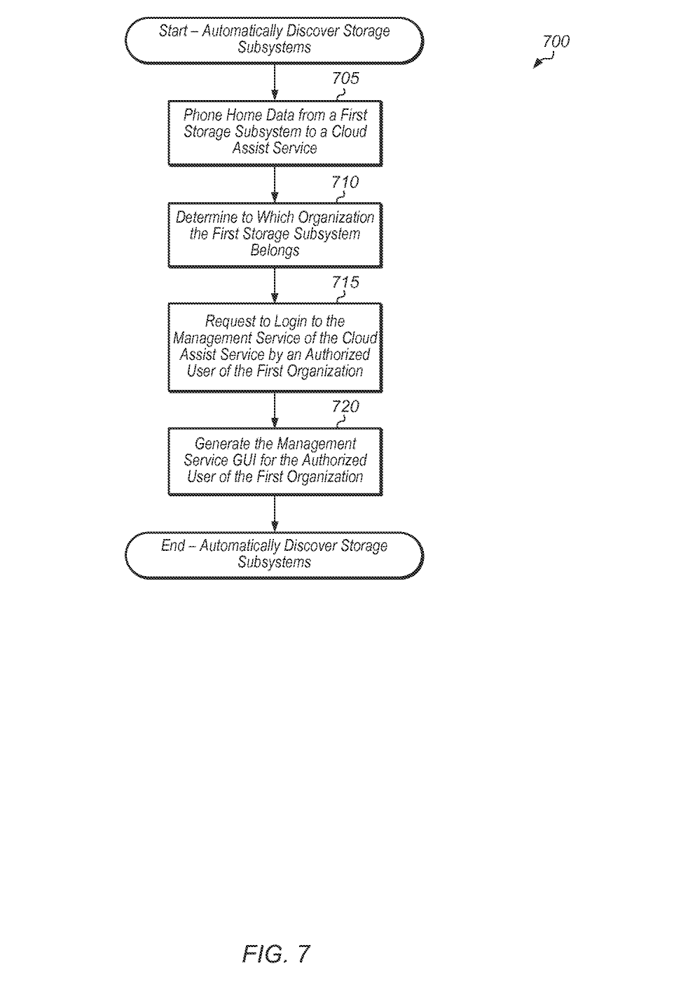

Turning now to FIG. 7, one embodiment of a method 700 for automatically discovering a storage subsystem of a given organization is shown. Any of the servers, cloud assist logic units, and/or management services described herein in combination with a storage controller (e.g., storage controller 210 of FIG. 2) may generally operate in accordance with method 700. In addition, the steps in this embodiment are shown in sequential order. However, some steps may occur in a different order than shown, some steps may be performed concurrently, some steps may be combined with other steps, and some steps may be absent in another embodiment.

A first storage subsystem may phone home performance data to a cloud assist service (block 705). It may be assumed for the purposes of this discussion that this is the first time since becoming operational that the first storage subsystem is phoning home performance data to the cloud assist service. In response to receiving the performance data from the first storage subsystem, the cloud assist service may determine to which organization the first storage subsystem belongs (block 710). In various embodiments, the cloud assist service may identify the organization from the internet protocol (IP) address, domain name, and/or other identifying information of the first storage subsystem. For the remainder of the discussion regarding method 700, the organization to which the first storage subsystem belongs may be referred to as the first organization.

At a later point in time, an administrator or other authorized user of the first organization may request to login to the management service of the cloud assist service (block 715). In response to detecting the request to login to the management service of the cloud assist service, the cloud assist service may generate the management service GUI for the administrator or other authorized user to view the status of all of the storage subsystems of the first organization (block 720). The cloud assist service may automatically include the first storage subsystem in the list of storage subsystems of the first organization and populate the management service GUI with status data of the first storage subsystem from the performance data which was previously generated and sent to the cloud assist service by the first storage subsystem. After block 720, method 700 may end.

It is noted that the above-described embodiments may comprise software. In such an embodiment, the program instructions that implement the methods and/or mechanisms may be conveyed or stored on a non-transitory computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a plurality of storage subsystems associated with a first organization; and
a server external to the plurality of storage subsystems, wherein the server is configured to:
host a management service to monitor and manage the plurality of storage subsystems;
generate a graphical user interface (GUI) showing a status of the plurality of storage subsystems in a single view;
allow a user to update configuration of one or more of the plurality of storage subsystems responsive to determining the user is logging in to the management service from within the first organization; and
prevent the user from updating configuration of any of the plurality of storage subsystems responsive to determining the user is not logging in from within the first organization.

2. The system as recited in claim 1, wherein the server is further configured to enable the user to login to the management service from a browser located externally to any network of the first organization, and wherein the server is cloud-based.

3. The system as recited in claim 1, wherein the plurality of storage subsystems reside in at least two different locations associated with the first organization.

4. The system as recited in claim 1, wherein the server is further configured to:
receive performance data generated by a new storage subsystem, wherein the new storage subsystem has not previously sent performance data to the server;
determine that the new storage subsystem is associated with the first organization; and
automatically add the new storage subsystem to the management service of the first organization.

5. The system as recited in claim 4, wherein the performance data includes at least one of volume count, queue depth, read bandwidth, read input/output operations per second (IOPS), read latency, write bandwidth, write IOPS, and write latency.

6. The system as recited in claim 4, wherein the server is configured to determine that the new storage subsystem is associated with the first organization from an internet protocol (IP) address of the new storage subsystem.

7. The system as recited in claim 4, wherein the server is configured to automatically add the new storage subsystem to the management service of the first organization without user intervention.

8. A method comprising:
hosting a management service to monitor and manage a plurality of storage subsystems of a first organization, wherein the management status is hosted externally to the first organization;
generating a graphical user interface (GUI) showing a status of the plurality of storage subsystems in a single view;
allowing a user to update configuration of one or more of the plurality of storage subsystems responsive to determining the user is logging in to the management service from within the first organization; and
preventing the user from updating configuration of any of the plurality of storage subsystems responsive to determining the user is not logging in from within the first organization.

9. The method as recited in claim 8, wherein the management service is hosted on a cloud-based server, wherein the method further comprising enabling the user to login to the management service from a browser located externally to any network of the first organization.

10. The method as recited in claim 8, wherein the plurality of storage subsystems reside in at least two different locations associated with the first organization.

11. The method as recited in claim 8, further comprising:
receiving performance data generated by a new storage subsystem, wherein the new storage subsystem has not previously sent performance data to the server;
determining that the new storage subsystem is associated with the first organization; and
automatically adding the new storage subsystem to the management service of the first organization.

12. The method as recited in claim 11, wherein the performance data includes at least one of volume count, queue depth, read bandwidth, read input/output operations per second (IOPS), read latency, write bandwidth, write IOPS, and write latency.

13. The method as recited in claim 11, further comprising determine that the new storage subsystem is associated with the first organization from an internet protocol (IP) address of the new storage subsystem.

14. The method as recited in claim 11, further comprising automatically add the new storage subsystem to the management service of the first organization without user intervention.

15. A non-transitory computer readable storage medium storing program instructions, wherein the program instructions are executable by a processor to:
host a management service to monitor and manage a plurality of storage subsystems of a first organization, wherein the management status is hosted externally to the first organization;
generate a graphical user interface (GUI) showing a status of the plurality of storage subsystems in a single view;
allow a user to update configuration of one or more of the plurality of storage subsystems responsive to determining the user is logging in to the management service from within the first organization; and
prevent the user from updating configuration of any of the plurality of storage subsystems responsive to determining the user is not logging in from within the first organization.

16. The non-transitory computer readable storage medium as recited in claim 15, wherein the management service is hosted on a cloud-based server, wherein the program instructions are further executable by a processor to enable the user to login to the management service from a browser located externally to any network of the first organization.

17. The non-transitory computer readable storage medium as recited in claim 15, wherein the plurality of storage subsystems reside in at least two different locations associated with the first organization.

18. The non-transitory computer readable storage medium as recited in claim 15, wherein the program instructions are further executable by a processor to:
receive performance data generated by a new storage subsystem, wherein the new storage subsystem has not previously sent performance data to the server;
determine that the new storage subsystem is associated with the first organization; and
automatically add the new storage subsystem to the management service of the first organization.

19. The non-transitory computer readable storage medium as recited in claim 18, wherein the performance data includes at least one of volume count, queue depth, read bandwidth, read input/output operations per second (IOPS), read latency, write bandwidth, write IOPS, and write latency.

20. The non-transitory computer readable storage medium as recited in claim 18, wherein the program instructions are further executable by a processor to determine that the new storage subsystem is associated with the first organization from an internet protocol (IP) address of the new storage subsystem.
